(19) United States
(12) Patent Application Publication
(10) Pub. No.: US 2013/0276119 A1
(43) Pub. Date: Oct. 17, 2013

(54) SYSTEM, METHOD, AND COMPUTER PROGRAM PRODUCT FOR REACTING TO A DETECTION OF AN ATTEMPT BY A PROCESS THAT IS UNKNOWN TO CONTROL A PROCESS THAT IS KNOWN

(71) Applicant: Jonathan L. Edwards, Portland, OR (US)

(72) Inventor: Jonathan L. Edwards, Portland, OR (US)

(21) Appl. No.: 12/046,143

(22) Filed: Mar. 11, 2008

(51) Int. Cl. G06F 21/06

(52) U.S. Cl. 726/24

(57) ABSTRACT

A system, method, and computer program product are provided for reacting to a detection of an attempt by a process that is unknown to control a process that is known. In operation, an attempt by a first process that is unknown to control a second process that is known is detected. Furthermore, there is a conditional reaction based on the detection.

### FIELD OF THE INVENTION

The present invention relates to computer security, and more particularly to reacting to unknown processes.

### BACKGROUND

Some current virus scan software packages are effective at stopping certain malicious behavior. However, there are a couple of weaknesses with these software packages. One of the first things many viruses or other pieces of malware do is to inject themselves into a context of a process that is normally present in a computing environment. For example, on a Windows operating system this may be an “explorer.exe” process or a “winlogon.exe” process.

The malware does this for a number of reasons. One reason is that by injecting itself into the context of a process that is normally present, the malware is harder to detect. For example, the original process may end and the user may not see anything suspicious executing.

Another reason that malware uses known processes is that these processes are often trusted by users and by security software. For example, Internet Explorer is trusted by firewalls, including Windows operating system firewalls, to communicate with the internet. If malware (e.g. a virus, etc.) injects code into Internet Explorer, the virus can download more malicious code or upload passwords without the firewall blocking the action or even raising a flag.

Additionally, traditional rules of security software often trust known processes (e.g. winlogon.exe, etc.) to write to several important areas of a registry. Because this often happens very early in the lifecycle of a virus or malware, it is desirable for a security product to detect, and block the malware actions. There is thus a need for overcoming these and/or other issues associated with the prior art.

### SUMMARY

A system, method, and computer program product are provided for reacting to a detection of an attempt by a process that is unknown to control a process that is known. In operation, an attempt by a first process that is unknown to control a second process that is known is detected. Furthermore, there is a conditional reaction based on the detection.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for reacting to a detection of an attempt by a process that is unknown to control a process that is known, in accordance with one embodiment.

FIG. 4 shows a system for reacting to a detection of an attempt by a process that is unknown to control a process that is known, in accordance with one embodiment.

FIG. 5 shows a method for reacting to a detection of an attempt by a process that is unknown to control a process that is known, in accordance with another embodiment.

### DETAILED DESCRIPTION

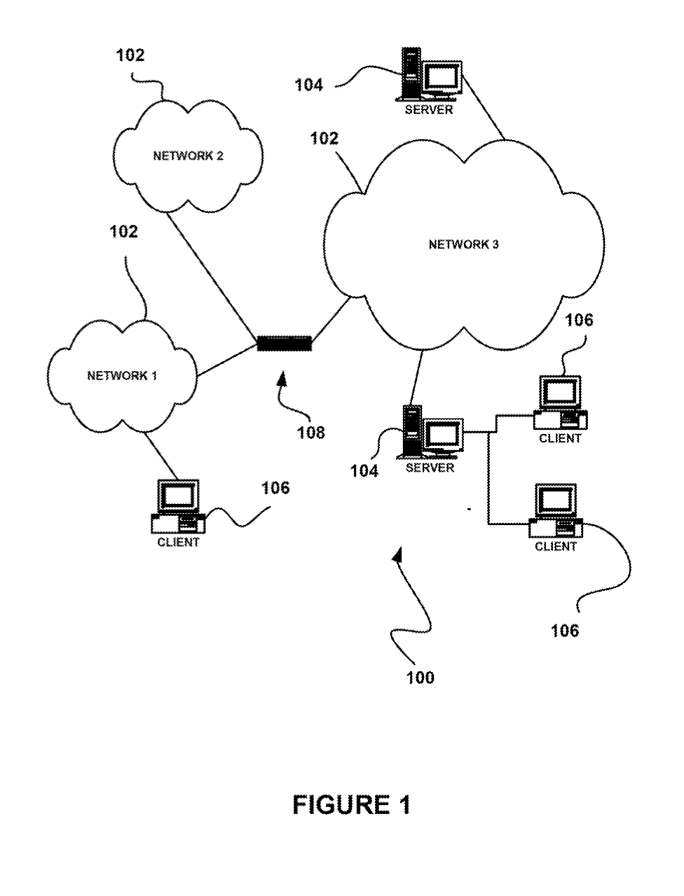

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

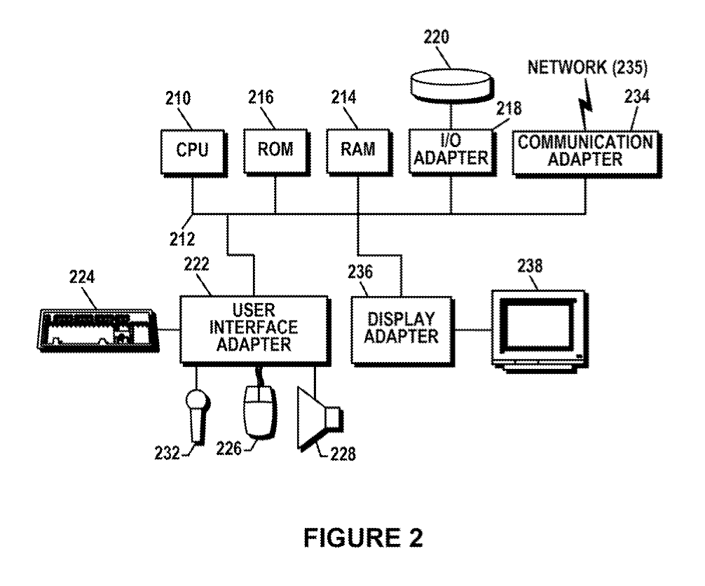

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

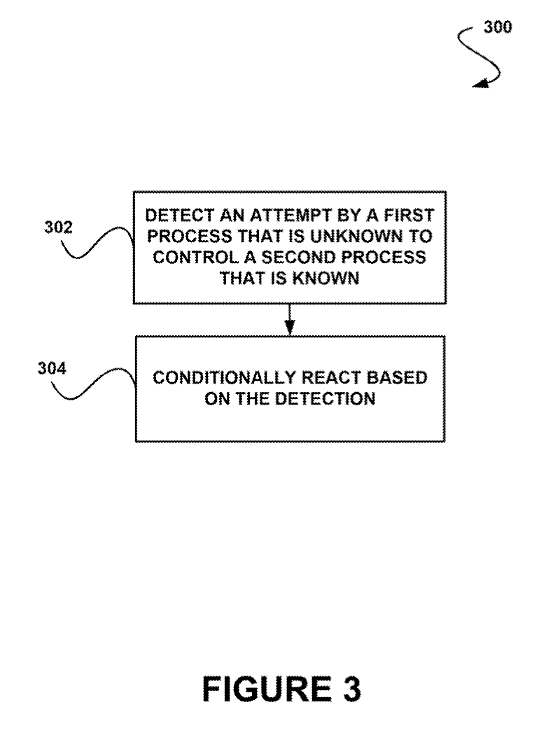

FIG. 3 shows a method 300 for reacting to a detection of an attempt by a process that is unknown to control a process that is known, in accordance with one embodiment. As an option, the method 300 may be implemented in the context of the architecture and environment of FIGS. 1 and/or 2. Of course, however, the method 300 may be carried out in any desired environment.

In operation, an attempt by a first process that is unknown to control a second process that is known is detected. See operation 302. In the context of the present description, a process refers to any instance of a computer program or application that is capable of being executed. For example, in various embodiments, the process may include, but is not limited to, a process associated with a web browser, a word processor, a security application, and/or any other process that meets the above definition.

Additionally, the attempt by the first process to control the second process may include any type of attempt to control an aspect of a process. For example, in various embodiments, the attempt to control the second process may include, attempting to inject code into the second process, attempting to control a write operation associated with the second process, attempting to access certain functionality associated with the second process, and/or any other attempt to control an aspect of the second process.

As shown further, there is a conditional reaction based on the detection. See operation 304. In this case, the reacting may include any number of active or passive reactions. For example, in various embodiments, the reacting may include blocking the attempt of the first process to control the second process, categorizing the second process as an untrusted process, allowing the attempt by the first process to control the second process and categorizing the second process as an untrusted process, performing an additional analysis, and/or any other reaction.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

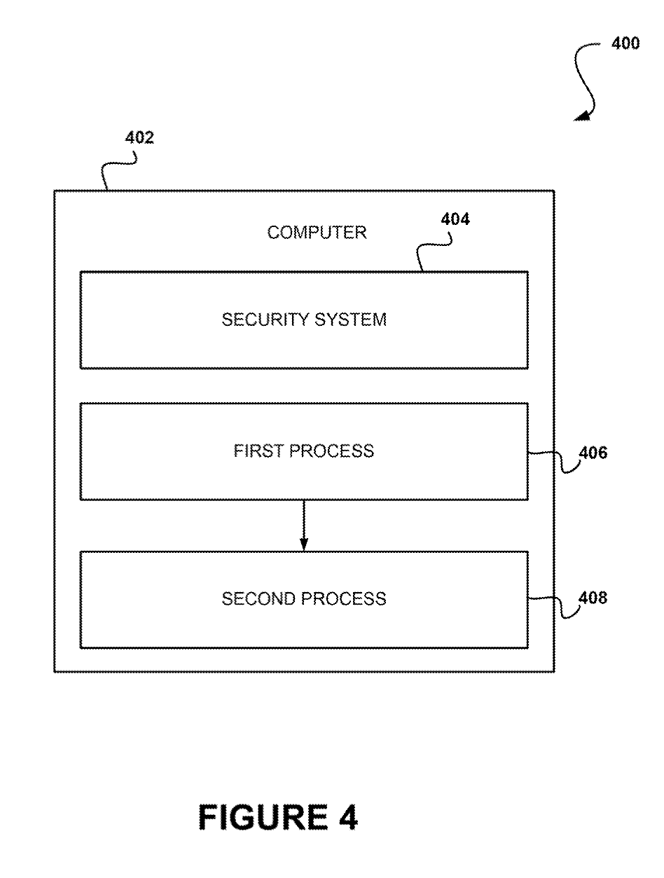

FIG. 4 shows a system 400 for reacting to a detection of an attempt by a process that is unknown to control a process that is known, in accordance with one embodiment. As an option, the present system 400 may be implemented in the context of the description of FIGS. 1-3. Of course, however, the system 400 may be implemented in any desired environment. It should also be noted that the aforementioned definitions may apply during the present description.

As shown, a device 402 is provided including a security system 404. In various embodiments, the device may include any device capable of including a security system and/or executing processes. For example, in various embodiments, the device may include a desktop computer, a notebook computer, a handheld computer, a PDA, a mobile phone, and/or any other device that meets the above definition.

Furthermore, the security system 404 may include any security system capable of implementing security measures. For example, in various embodiments, the security system may include a malware scanner, a virus scanner, anti-spyware software, and/or any other security software. In various embodiments, the security system 404 may include software provided by an operating system of the device 402 and/or a software package separate from security software provided by the operating system.

In operation, a first process 406 that is unknown may attempt to control a second process 408 that is known. In this case, a known process refers to any process whose execution and/or results have been or may be verified. In one embodiment, the second process 408 may include a previously verified process.

In one case, the second process 408 may be known to be trusted. For example, the second process 408 may be white listed. In other words, the second process 408 may be included in a list of known and trusted programs.

As an option, the list of trusted and known processes may be a configurable list. For example, as processes are verified and become trusted, the list may be updated with the trusted process. As another option, the list may be a global list that is continuously updated with trusted processes.

Furthermore, an unknown process refers to any process whose execution and/or results have not been verified, or have been verified but have been determined to be untrusted. For example, the first process 406 may be untrusted. In this case, the first process 406 may not be white listed. Additionally, the first process 406 may be on a black list (e.g. a known malicious process) or may not be on a list of known or trusted processes.

It should be noted that the attempt of the first process 406 to control the second process 408 may include various types of controlling. In one embodiment, the attempt by the first process 406 to control the second process 408 may include an attempt to insert code into the second process. In this case, the code may include malicious code.

As an option, the computer 402 and/or the security system 404 may include computer code for scanning the code. In this case, the scanning may include comparing the code with a plurality of signatures. For example, the code may be compared to a plurality of known malicious signatures in a database. As another example, the code may be compared to a plurality of known trusted signatures.

In another embodiment, the attempt by the first process 406 to control the second process 408 may include an attempt to control the second process 408 so as to write to memory. For example, the first process 406 may control the second process 408 to write data or specific information to memory. In various embodiments, this data may include passwords, financial information, and/or any other data.

In still another embodiment, the attempt by the first process 406 to control the second process 408 may include an attempt to control the second process 408 so as to create a thread. In this case, a thread refers to any execution instance of a computer program or application. For example, the first process 406 may attempt to launch a thread in the second process 408.

Detecting the attempt by the first process 406 to control the second process 408 may be accomplished in a variety of ways. In various embodiments, the detecting may be performed utilizing at least one of a hook and a call back. For example, the detecting may be performed utilizing user-mode hooking, kernel-mode hooking, callbacks associated with the operating system (e.g. callbacks from Windows, etc.), and/or various other mechanisms.

In this case, hooking refers to any technique of employing hooks to make a chain of procedures as an event handler. Furthermore, a callback refers to any executable code that may be passed as an argument to other code. In some cases, the callback may allow a lower-level software layer to call a subroutine or function defined in a higher-level layer.

Once the attempt is detected, there is a conditional reaction based on the detection. In one embodiment, the reacting may include preventing the attempt by the first process 406 to control the second process 408. In some cases, this may stop potentially malicious code included in the first process 406 from hiding from the security system 404 and performing malicious activities.

In another embodiment, the reacting may include categorizing the second process 408 as an untrusted process. In this case, the second process 408 may be entered into a list including a plurality of untrusted processes. In other words, the attempt by the first process 406 to control the second process 408 may be allowed to succeed, however, the second process 408 which has been compromised with potentially malicious code may be considered untrustworthy.

For example, in the case that malicious code associated with the first process 406 attempts to perform an action that may trigger file or registry rules, then the second process 408 may be blocked because the process may no longer be trusted. If code associated with the first process 406 is determined not to be malicious, then the second process 408 may be allowed to perform required operations. As an option, after successful execution of the second process 408, the first process 406 may be verified and added to a list of known and trusted processes.

In one embodiment, the second process 408 may be allowed to proceed and further analysis may be performed on the first process 406. In this case, the further analysis may include verifying the first process 406 as a trusted process. Upon verification, the first process 406 may then be inserted into a list of trusted processes.

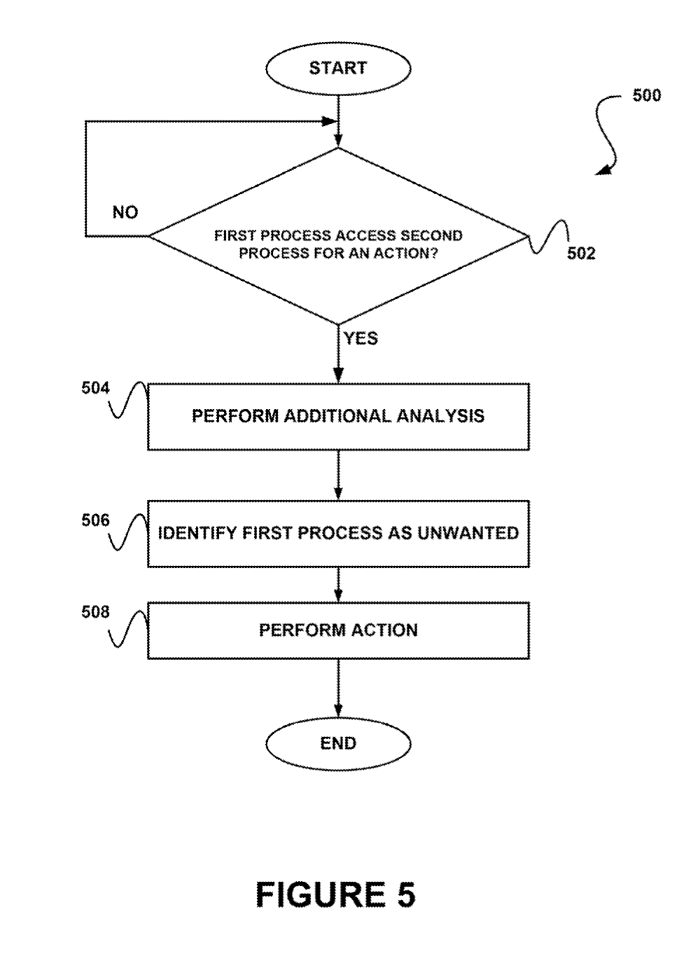

FIG. 5 shows a method 500 for reacting to a detection of an attempt by a process that is unknown to control a process that is known, in accordance with another embodiment. As an option, the method 500 may be implemented in the context of the architecture and environment of FIGS. 1-4. Of course, however, the method 500 may be carried out in any desired environment. Again, the aforementioned definitions may apply during the present description.

As shown, it is determined whether an unknown first process accessed a second known process for performing an action. See operation 502. In this case, the action may include any action such as injecting code and/or creating thread access for a program associated with the first process.

In one embodiment, the first process may access the second process by opening an application associated with the second process. In another embodiment, the first process may access the second process by opening the second process directly. In still another embodiment, the first process may access the second process by invoking a thread in the second process.

If it is determined that the first process has accessed the second process for performing an action, there is a conditional reaction. As an option, the reacting may include an additional analysis. See operation 504.

In this case, the additional analysis may include a variety of analysis including a scan (e.g. a malware scan, etc.). In one embodiment, the attempt by the first process to control the second process may be conditionally prevented, based on results of the analysis. For example, if the additional analysis determines that the first process includes malicious code, and the first process has attempted to inject this malicious code into the second process, the control of the second process by the first process may be prevented.

On the other hand, if after the additional analysis it is determined that the first process does not include malicious code, the attempt by the first process to control the second process may be allowed. In some cases, even if the first process is determined to include malicious code, the control of the second process by the first process may be allowed. In these cases, the second process may be prevented from executing completely or partially. Furthermore, the second process may then he included in a list of untrusted processes as a result of being compromised.

As shown further, the first process may be identified as unwanted. See operation 506. In one embodiment, this identification may be performed by the additional analysis of operation 504.

In another embodiment, identifying the first process as unwanted may include performing an analysis on the first process. In this case, the analysis may include comparing the first process with a plurality of known trusted and/or untrusted processes. For example, a signature associated with the first process may be compared to a list of known trusted or untrusted signatures stored in a database.

Once the analysis as been performed, an action is performed in response to the attempt of the first process to control the second process. See operation 508. In this case, the action may include allowing the first process to control the second process, or not allowing the first process to control the second process.

It should be noted that, even if it is determined that the first process is not included in a list of trusted or untrusted processes, the first process may be allowed to control the second process. In this case, the first and/or the second process may be allowed to perform actions initiated by that process. In some cases, the actions that are allowed to be performed by the processes may be regulated.

In one embodiment, the first and/or the second processes may be allowed to perform actions initiated by the processes until the first and/or the second process attempt to perform an action that may trigger a file or registry rule. Upon an attempt to perform an action that may trigger a file or registry rule, the first and/or second process may be halted. Furthermore, the first and/or second process may be further evaluated for integrity.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer readable medium comprising computer executable instructions stored thereon to cause a processor to:
detect an attempt by a first process to control a second process by attempting to cause the second process to perform an action, wherein the first process is unknown and the second process is known;
allow the attempted control;
perform analysis of the second process after allowing the first process to control one or more aspects of the second process to determine whether the first process or second process is trusted; and
react conditionally based on the analysis.

2. The non-transitory computer readable medium of claim 1, wherein the second process is known to be trusted,

3. The non-transitory computer readable medium of claim 1, wherein the second process is white listed.

4. The non-transitory computer readable medium of claim 1, wherein the first process is untrusted.

5. The non-transitory computer readable medium of claim 1, wherein the executable instructions to cause the processor to detect an attempt by the first process to control the second process further comprise instructions to cause the processor to detect an attempt by the first process to insert added code into the second process.

6. The non-transitory computer readable medium of claim 5, wherein the added code includes malicious code.

7. The non-transitory computer readable medium of claim 5, further comprising executable instructions to cause the processor to scan the added code.

8. The non-transitory computer readable medium of claim 7, wherein the executable instructions to cause the processor to scan comprise instructions to cause the processor to compare the added code with a plurality of signatures.

9. The non-transitory computer readable medium of claim 1, wherein the executable instructions to cause a processor to detect an attempt by the first process to control the second process comprise instructions to detect an attempt to control the second process so as to write to memory.

10. The non-transitory computer readable medium of claim 1, wherein the executable instructions to cause a processor to detect an attempt by the first process to control the second process comprise instructions to cause the processor to detect an attempt to control the second process so as to create a thread.

11. The non-transitory computer readable medium of claim 1, wherein the executable instructions to cause the processor to react comprise instructions to cause the processor to prevent a subsequent attempt by the first process to control the second process.

12. The non-transitory computer readable medium of claim 1, wherein the executable instructions to cause the processor to react comprise instructions to cause the processor to categorize the second process as an unfrosted process.

13. The non-transitory computer readable medium of claim 1, wherein the executable instructions to cause the processor to react comprise instructions to cause the processor to categorize the second process as an untrusted process based on the allowance.

14. The non-transitory computer readable medium of claim 1, wherein the executable instructions to cause the processor react comprise instructions to cause the processor to categorize the second process as an untrusted process based on the analysis.

15. The non-transitory computer readable medium of claim 1, wherein the executable instructions to cause the processor to perform analysis comprise instructions to cause the processor to perform a scan.

16. The non-transitory computer readable medium of claim 11, wherein the executable instructions to cause the processor to prevent a subsequent attempt by the first process to control the second process comprise instructions to cause the processor to prevent the subsequent attempt based on results of the analysis.

17. The non-transitory computer readable medium of claim 1, wherein the executable instructions to cause the processor to detect are performed by executable instructions to cause the processor to utilize at least one of a hook and a call back.

18. A method, comprising:
detecting an attempt by a first process to control a second process by attempting to cause the second process to perform an action, wherein the first process is unknown and the second process is known;
allowing the attempted control;
performing analysis of the second process after allowing the first process to control one or more aspects of the second process to determine whether the first process or second process is trusted; and
reacting conditionally based on the analysis.

19. A system, comprising:
a computer program product stored in memory, the computer program product comprising computer program instructions; and
a processor operatively coupled to the memory, and configured to execute the computer program instructions, the computer program instructions causing the processor to:
detect an attempt by a first process to control a second process by attempting to cause the second process to perform an action, wherein the first process is unknown and the second process is known;
allow the attempted control;
perform analysis of the second process after allowing the first process to control one or more aspects of the second process to determine whether the first process or second process is trusted; and
react conditionally based on the analysis.

20. (canceled)

21. The system of claim 19 further comprising:
the computer program instructions causing the processor to:
detect an attempt by the first process to insert added code into the second process.
